(19) United States
(12) Patent Application Publication
(10) Pub. No.: US 2009/0083301 A1
(43) Pub. Date: Mar. 26, 2009

(54) WEB-BASED ADDRESS DATABASE AND METHOD OF GENERATING A PHYSICAL ADDRESS

(76) Inventor: Benedikt Leibinger, Freiburg (DE)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 11/858,607

(22) Filed: Sep. 20, 2007

(51) Int. Cl. G06F 17/30

(52) U.S. Cl. 707/102; 707/E17.045

(57) ABSTRACT

A method for generating a physical address associated with one or more email addresses is provided. The method includes providing an email address and querying a database for the email address. The physical address associated with said email address is then provided. The present invention also relates to a method for establishing a relational database. The method includes obtaining a user's actual name associated with that user's email address. The user's physical address is then associated with the user's email address.

### FIELD OF THE INVENTION

The present invention relates to a web-based address database that associates physical addresses to email addresses.

### BACKGROUND

The internet affords every person more or less anonymity and with it, the possibility of also adopting various identities. Such identities are associated, on the internet, with an e-mail or IP address. E-mail addresses last as long as the user needs them. IP addresses can dynamically change and are not directly associated with a person. Furthermore, IP addresses can also be utilized by multiple people at the same time.

A typical internet user normally utilizes no fewer than three different e-mail addresses, for example, professional, private, and the so-called throw-away address, i.e. those used to register for secured websites. Each of these email addresses is normally associated to a specific identity and with it contact data, (for example, name, private address, business address).

In business, the trend has become to separate private and business use of the internet and email. Often, business computers, for reasons of data security, should not be used for private purposes. Thus, a trend to a second (business) identity arises.

### SUMMARY

The present invention relates to a method for generating a physical address. The method includes providing an email address and querying a database for the email address. The method also includes identifying the physical address associated with said email address.

The present invention also relates to a method for establishing a relational database. The method includes obtaining a user's actual name associated with that user's email address. The method also includes associating the user's physical address with the user's email address.

### BRIEF DESCRIPTION OF THE DRAWINGS

These and other objects, features and advantages of the present invention will become apparent from the following detailed description and the appended drawings in which:

FIG. 1 is a depiction of a screen shot of a user interface for inputting personal data;

FIG. 1a is a depiction of data flow;

FIG. 2 is a depiction of a message screen regarding registration confirmation;

FIG. 3 is a flow diagram depicting the steps for associating personal information to an email address;

FIG. 4 is a depiction of a screen shot of a user interface for a checkout;

FIG. 5 is a flow diagram depicting the steps for populating fields with personal information;

FIG. 6 is a depiction of a screen shot of a user interface for updating an email address location;

FIG. 6a is a flow diagram depicting the steps in updating an email address location;

FIG. 7 is a depiction of a screen shot of a user interface for obtaining geographical coordinates of an email address; and

FIG. 7a is a flow diagram depicting the steps in obtaining geographical coordinates of an email address.

### DETAILED DESCRIPTION OF THE PREFERRED EMBODIMENTS

As a result of the system of the present invention, internet anonymity and data security are further advanced. The separate identities just as well should also have further meaning. Since the identities further associate natural persons, in different functions (i.e. private people, business persons, group members, etc.), to email addresses, a good index key for a directory is therefore demonstrated.

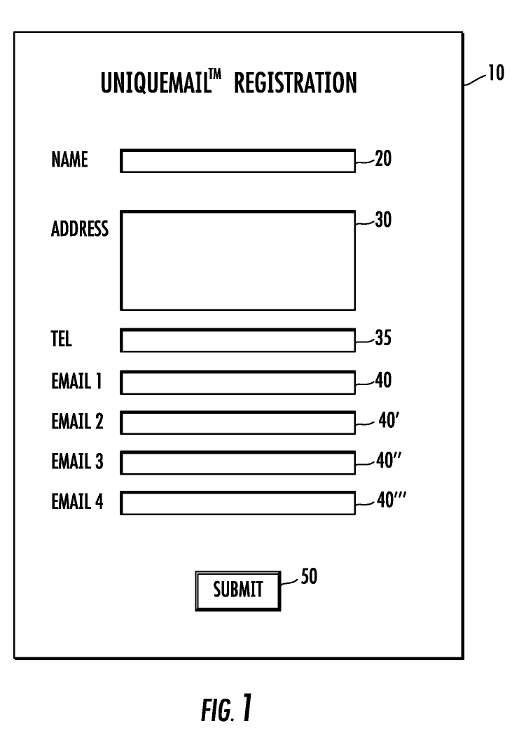

A registration screen 10 is shown in FIG. 1 where a user inputs various personal information. The screen 10 is generally part of an internet webpage accessible to a user with a computer 70 connected to the internet (FIG. 1a). The screen 10 contains fields for a user's actual name 20, physical address 30 and telephone number 35. Finally, there are fields 40, 40′, 40″, 40′″ for a user to input email addresses. Four email fields 40, 40′, 40″, 40′″ are shown however, it should be understood that the registration screen 10 can have fewer or more than four email fields.

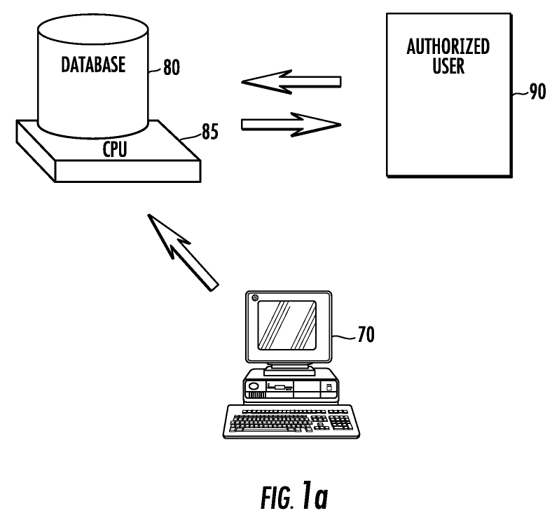

Once the user enters the information into the appropriate fields, the user clicks the submit button 50 and the information is uploaded to a database 80. The user will then receive a confirmation message 60 as shown in FIG. 2. The confirmation message indicates that a confirmation email has been sent to each email address entered into the registration screen 10. The confirmation can also/instead be sent via “snail mail” (postal service) to the user's physical address.

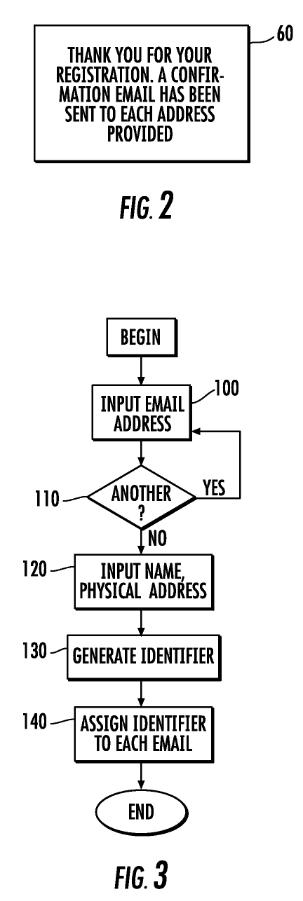

FIG. 3 depicts the process by which the information provided by the user is processed into the database 80. An email address is input in step 100, if an additional email address is to be entered, step 100 is repeated. If no further email addresses are to be entered, the user's personal coordinates, i.e. name, physical address, telephone number, are entered in step 120. The database 80 comprises a central processing unit (CPU) 85 that generates a unique identifier in step 130. The unique identifier is then associated, in step 140, with each of the email addresses provided by the user.

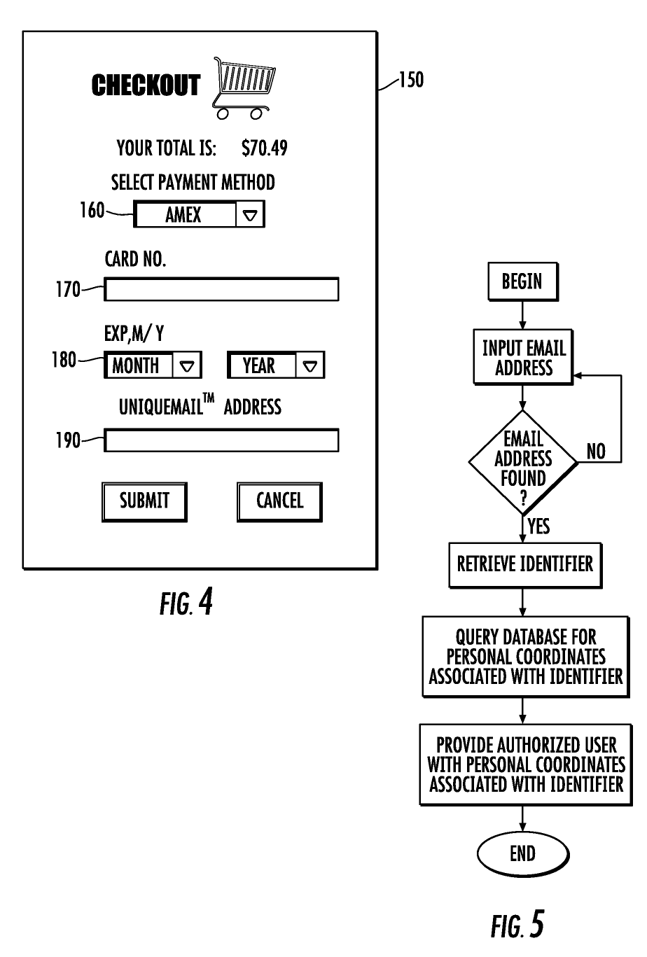

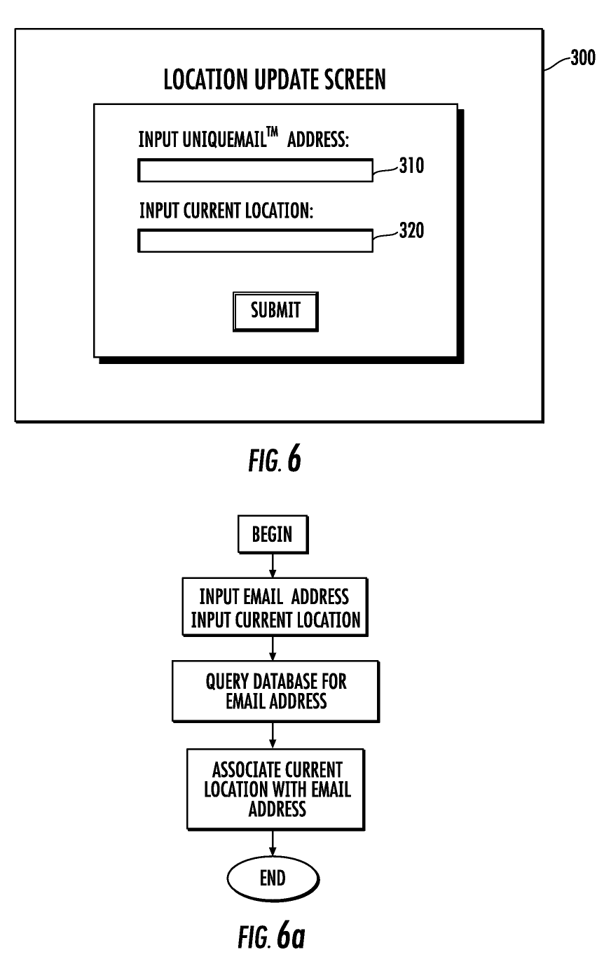

In use, the method of the present invention is suitable for on-line merchants that utilize a “check out” screen for concluding on-line transactions. Generally, a check out screen is where a user will enter their payment information as well as their personal coordinates, i.e. name, address, etc. As shown by the screen shot in FIG. 4, a simplified check out screen 150 is provided by the present invention. A user simply enters the requisite payment information in the appropriate fields 160, 170, 180, and their email address in field 190. If the on-line merchant is an authorized user 90 who has read-only access to the database 80, all of the database 80 stored information on the user's name, address and telephone number become available, as described below. Once a user inputs an email address into field 190 and submits the payment to the authorized user/merchant 90, the authorized user/merchant 90 carries out the steps shown in the flow diagram on FIG. 5.

The email address provided in field 190 is provided to the CPU 85 in step 200. If the email address is not present in the database 80, the user will be requested to provide another email address. If the email address is found, step 210, the unique identifier is retrieved in step 220. The database 80 is then queried in step 230 for the personal coordinates assigned to the unique identifier retrieved in step 220. The personal coordinates retrieved in step 230 are then provided to the authorized user/merchant 90 in step 240. The user can also select, during registration, which information is provided to the authorized user/merchant 90, e.g. address only, phone number only, alternate email address, etc. Furthermore, alternate addresses can be indicated for specific authorized users/merchants 90.

A further dimension is established, when e-mail addresses are assigned to articles and objects. With it, these things can have properties and contact information associated therewith, e.g. solar modules in solar parks, horizontal border markers, etc.

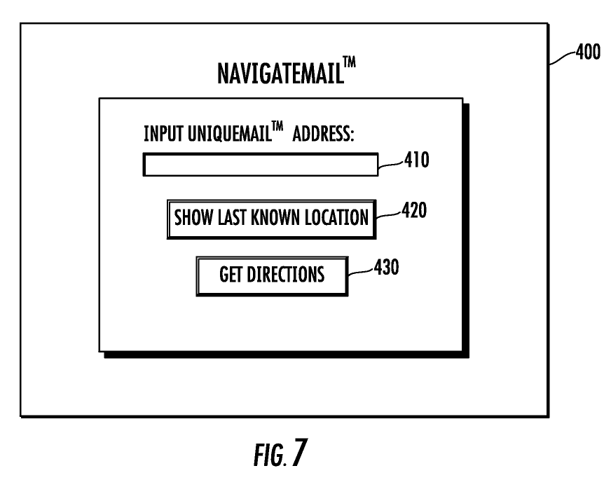

FIG. 6 is a screen shot of a user interface 300 for updating a user's location. A user simply inputs a previously registered email address into the appropriate field 310. The current location of the person (or object) associated with the email address is entered into the current location field 320. The information regarding the current location is provided to the CPU 85 and is then associated with the email address in the database 80. It should be noted that the current location can be a different value than the physical address associated with the email address. If the email address is associated with a person, the current location can represent the actual present location of the user. If the email address is associated with an object, the current location can be used in lieu of an address. The steps for updating a user's email location are shown in FIG. 6a.

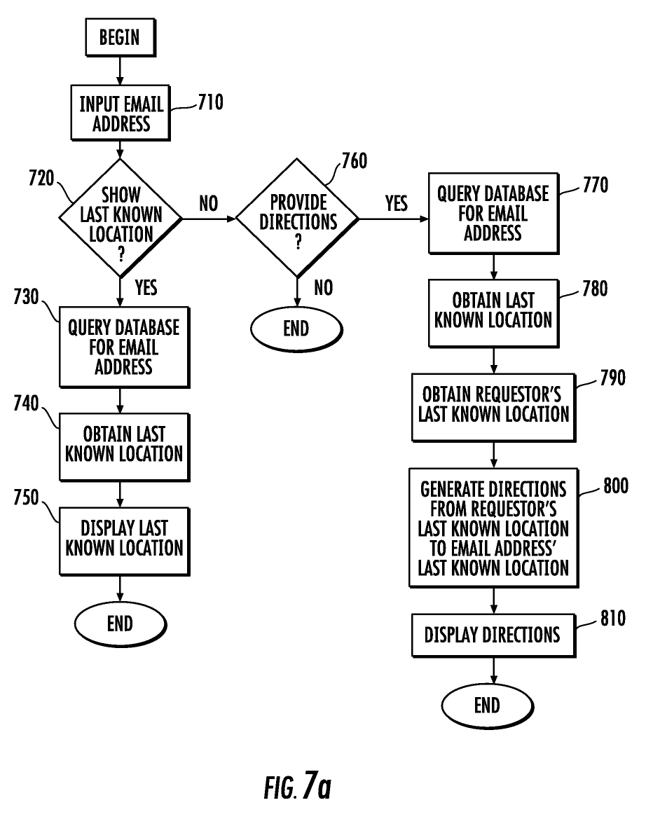

In order to call up a user's current location information, as shown in FIG. 7, a navigation user interface 400 is provided. A user inputs a registered email address into the appropriate field 410 and selects either the “Show Last Know Location” button 420 or the “Get Directions” button 430. The steps for carrying out the location retrieval are shown in FIG. 7a. A registered user's email address is entered in step 710, the requester can request either to have the registered user's last known location displayed or directions to the registered user's last known location. If the request is to display the location, the database is queried in step 730 for the email address. In step 740 the last known location is obtained and displayed in step 750. If directions to the registered user's last known location are desired, the database is queried for the email address in step 770. The last known location is obtained in step 780, and the requestor's last known address is obtained in step 790. Directions are then generated in step 800 using the requestor's last known location as the starting point and the registered user's last known location as the end point. The generated directions are displayed in step 810.

Since the functionality is based on the email address, the present invention can also be used to provide telephone calls that can be made to email addresses. Furthermore, the present invention can be used for billing and the payment of invoices. Invoices can be directed to email addresses and payments can likewise be forwarded to email addresses. The present invention can also be used in direct marketing, forwarding advertisement materials directed to a specific group.

The versatility of the present invention allows it to be practiced by, but not limited to, telecommunication companies, mail and delivery services, credit institutions, advertisement agencies, warehouses and bulk retailers, etc.

What is claimed is:

1. A method of determining personal coordinates of a user comprising the steps of:
a) providing a database having a central processing unit;
b) providing an interface;
c) inputting an email address into the interface;
d) querying the database for the email address; and
e) identifying the personal coordinates associated with said email address.

2. The method of claim 1, further comprising the step of:
retrieving an identifier associated with said email address.

3. The method of claim 2, further comprising the step of:
querying the database for the personal coordinates associated with said identifier.

4. The method of claim 1, wherein the personal coordinates are a user's name, physical address or telephone number.

5. The method of claim 2, wherein the identifier is associated with a plurality of email addresses of the same user.

6. A method for establishing a relational database comprising the steps of:
a) providing a database having a central processing unit;
b) providing a user interface, for inputting data, in communication with said database;
c) entering at least one email address into the database;
d) entering personal coordinates associated with the at least one email address into the database;
e) generating an identifier; and
f) associating the identifier with the at least one email address and the personal coordinates.

7. The method of claim 6, wherein the personal coordinates associated with the at least one email address can be obtained by an authorized user.

8. The method of claim 7, wherein the authorized user obtains the personal coordinates associated with the at least one email address by the following steps:
i) inputting an email address into the interface;
ii) querying the database for the email address; and
iii) retrieving an identifier associated with the email address;
iv) querying the database for the personal coordinates associated with said identifier; and
v) identifying the personal coordinates associated with said email address.

9. The method of claim 6, wherein the personal coordinates are a user's name, physical address or telephone number.

10. The method of claim 6, wherein the identifier can be associated with a plurality of email addresses of the same user.
